(19) United States
(12) Patent Application Publication
(10) Pub. No.: US 2025/0287924 A1
(43) Pub. Date: Sep. 18, 2025

(54) HARNESS ASSEMBLY WITH SINGLE POINT ATTACHMENT

(71) Applicant: Nick Smart, Tampa, FL (US)

(72) Inventor: Nick Smart, Tampa, FL (US)

(21) Appl. No.: 18/604,323

(22) Filed: Mar. 13, 2024

(51) Int. Cl. A01K 27/00; A01K 1/02

(52) U.S. Cl. CPC A01K 27/002; A01K 1/0263

(57) ABSTRACT

A harness assembly with a single point attachment point means for everyday use, such as with a leash, and which is capable for safely and securely restraining an animal within a vehicle. The harness assembly comprises multiple webbing straps interconnected by at least two O-rings and several stitching arrangements to form a skeletal structure and a D-ring securely connected to the skeletal structure to provide function for a single point attachment. More particularly, the multiple webbing straps include a pair of neck straps, a chest strap, a back strap, a lateral connecting strap and a rear connecting strap. Complementing members are provided at the ends of the lateral strap and back strap to form quick release buckles which are capable of being disengaged even when the lateral and back straps are under tension such as the result of a high impact force.

### PRIOR ART

Harness systems, particularly those developed for restraining pets, are very well known in the art. While the simple adjustable pet collar about the animal's neck, provided with a D-ring or O-ring capable of being attached to a walking leash, remains in use today, pet harness systems have advanced rapidly in recent years due to awareness of pet safety and comfortability. For instance, harness systems have been developed for restraining an animal, particularly a dog, within an automobile in a safe manner. For example, U.S. Pat. No. 5,915,335 to Holt, Jr. is directed to a dog car restraint using an adjustable collar and girth straps all of which are connected at the dog's back and has a harness strap which provides an insertion area about a car's seatbelt. However, not only is the harness system described in Holt, Jr. cumbersome, it does not provide the restrained dog with much mobility, it does not provide for quick release in the event of a high impact force nor does it provide a single point attachment means. U.S. Patent Application Publication 2014/0305384 A1 to Ramirez discloses another vehicular dog restraint in the form of a harness having a simple collar and girth combination webbing to which is secured an adjustable belt provided with a loop into which a conventional vehicular seat belt is engaged. While Ramirez does provide a single attachment means for the belt, it does not provide a quick release mechanism. WO Published Application 98-29281 to Mortensen et al. shows a pet restraining device which secures a dog or other pet utilizing an engagement means with a conventional automobile seat belt. The restraining device distributes the active force over the entire chest and shoulder of the dog. Mortensen et al. does provide a single attachment point but similar to other prior art, provides a looping means to engage a conventional seat belt. In U.S. Pat. No. 5,154,660 to Snyder et al. another pet restraining for transporting an animal comfortably and safely in a vehicle which has two points of attachment, one for a leash, another for a joining to a seatbelt.

Other pet harness systems have been developed which are constructed with adjustable webbing straps and having a single point attachment means. For instance, U.S. Pat. No. 8,561,577 B1 to Paxton et al. discloses a harness with a pair of neck straps connected to a pair of back straps via an O-ring, and coupled to a chest strap through a D-ring strap, a pair of side straps, an optional belly strap and a coupling strap. Paxton et al. utilizes buckle slides for both adjustment and for separation with the several straps. Paxton et al. also provides for a single point attachment. A significant drawback to Paxton et al. is that the webbing structure relies on buckle slides rather than being secured upon itself. In related U.S. Pat. No. 7,284,505 B1, Paxton et al. shows a similar harness adapted as a skijor system.

Numerous other patents show harness systems for various purposes having a single point attachment means for coupling to a leash including U.S. Patent Application Publication US 2021/0161104 A1 to Kruse et al., which relates to a guide dog harness having interconnections between a fabric panel and an adjustable buckle system, U.S. Patent Application 2019/0124890A1 to Kath which provides a harness system using plastic buckles with Velcro straps, U.S. Patent Application Publication US 2019/0297851 A1 to Nixon et al. which relates to pet harness and life vest with an inflatable bladder, and U.S. Pat. No. 6,694,923 B1 to Fouche which shows a harness with a stand-up leash incorporated within a plug in the harness. U.S. Design patent D841,261 to Backus et al. illustrates an ornamental design for a pet harness having multiple webbing straps connected to one another via O-rings. However, the Backus et al. system utilizes multiple buckles that are dangerous under tension. If there is an accident based on high impact force, the restrained dog could be in danger.

### BACKGROUND OF THE INVENTION

Harness systems for animals have been developed and improved in recent years such that the harness system can be connected to a leash for walking and training the animal and can be adapted to securely restrain an animal in a vehicle. Vehicular crash data clearly has described that some restraint is required for pets and particularly for dogs when the vehicle experiences a high force impact. However, pets, and particularly dogs, are difficult to restrain in an automobile as the standard vehicle restraining devices are designed for humans. Harness restraining systems for vehicles have relied upon interconnecting the conventional three-point seat belt system developed for human use to restrain the harnessed animal. One drawback of this prior art is the utilization of the human three-point seatbelt which limits the animal's movement and typically results in the animal becoming tangled. Another drawback to these harnesses is that they are quite cumbersome to use and often rely upon multiple buckles that are dangerous under tension. A more significant drawback is that while such vehicular harness restraint systems have proven crash test worthy, there is a danger that the animal will be trapped within the harness system under high impact circumstances.

The current three-point crash tested harnesses require that the three-point human seat belt system to be woven through the back of the harness; single attachment point harness systems have not proven to be crash test worthy. With the correct stitching pattern and materials, the single point attachment means is crash test worthy. The entire structure is supported by high tensile nylon which maintains the skeletal structure. It uses steel O-rings and stitching arrangements at many of the intersections of multiple webbing straps to ensure that the resulting webbing structure is one continuous piece rather than the webbing being sewn to the cloth fabric of the harness. A novel three layer looped stitching arrangement also is provided to securely attach a D-ring to the webbing structure, the D-ring being utilized as the single point attachment means. The single point attachment harness system of the present subject matter also utilizes quick release coupling means that enable fast and easy release of the animal even under tension.

### SUMMARY OF THE INVENTION

The present subject matter relates to a harness assembly with a single point attachment that is adaptable for both everyday use and for use as a restraining device in an automobile or other vehicle. In particular, the present subject matter is directed to a harness assembly having a continuous skeletal structure comprising multiple webbing straps securely connected by steel O-rings, looping and stitching arrangements, quick release coupling means and a single attachment means which is secured to the skeletal structure, suitable examples of which include a D-ring, a looped high tensile material and similar means which will be obvious to those skilled in the art. The single point attachment means, represented in the drawings as a D-ring, is designed for use with a leash or with a vehicle restraining device. The multiple webbing straps are composed of a high tensile nylon or other suitable material which provides strength and durability. The continuous skeletal structure of the present subject matter has proven crash test worthy.

Accordingly, it is an object of the present subject matter to provide a harness assembly for an animal having a single point attachment means which has the dual utility of a connecting means to a leash and restraining the animal within a vehicle.

It is another object of the present subject matter to provide a harness assembly which utilizes a D-ring as the single point attachment means

It is another object of the present subject matter to provide a crash tested animal harness assembly that does not require using the vehicular three-point conventional safety belt when restraining an animal in a vehicle.

It is a further object of the present subject matter to provide an animal harness assembly in the form of a continuous skeletal structure composed of multiple webbing straps of high tensile nylon which are interconnected by O-rings and looped stitching arrangements.

It is yet another object of the present subject matter to provide an animal harness assembly having a single point attachment means directly secured to one of the multiple webbing straps.

It is an additional object of the present subject matter to provide a three-layered stitched attachment point for securely attaching the single point attachment means to the animal harness assembly.

It is still another object of the present subject matter to provide at least one quick release coupling means to animal harness assembly wherein the coupling means is capable of quick release under tension.

It is a further object of the present subject matter to provide means to adjust the animal harness assembly to accommodate the size of the restrained animal.

### BRIEF DESCRIPTION OF DRAWINGS

FIG. 1 shows a perspective view of the harness assembly of the present subject matter in its intended environment.

FIG. 2 shows a plan view of the harness assembly of the present subject matter.

FIG. 3 shows a side perspective view of the chest portion of the harness assembly of the present subject matter.

FIG. 4 shows a top perspective view of the harness assembly of the present subject matter with the single point attachment feature.

FIG. 5 shows a detailed top plan view of an embodiment illustrating the single point attachment secured to the harness assembly of the present invention utilizing a stitching and webbing arrangement.

FIG. 6 shows a quick release buckle of the harness assembly of the present subject matter.

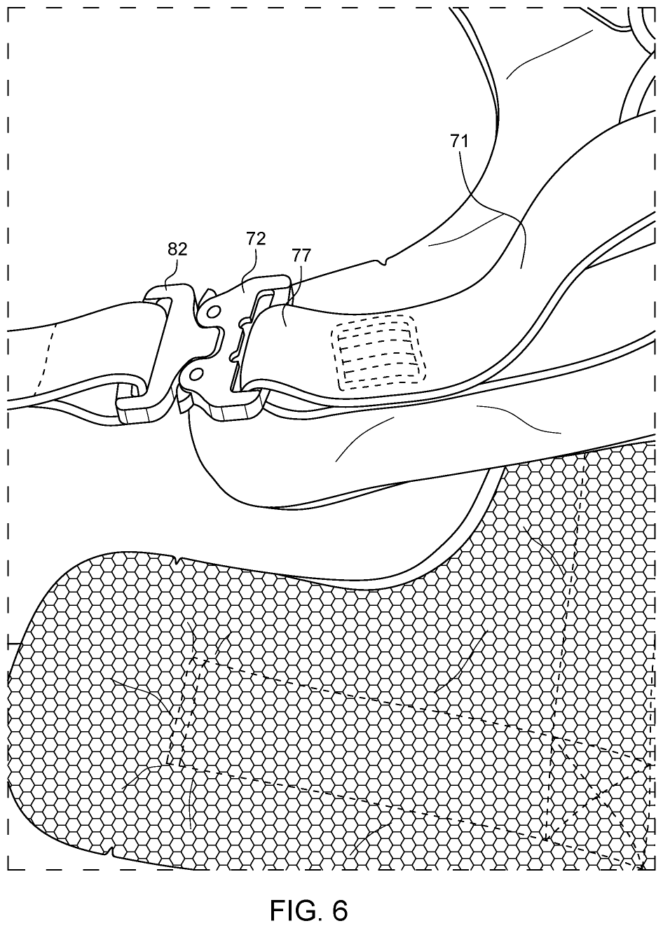

FIG. 7 shows a perspective view of a second embodiment of the harness assembly of the present subject matter.

### DETAILED DESCRIPTION OF THE INVENTION

The present subject matter is directed to a harness assembly provided with a single point attachment point means for everyday use, such as with a leash, and which is capable for safely and securely restraining an animal within a vehicle. Referring to the figures, the harness assembly of the present subject matter is in the form of a skeletal structure which utilizes a configuration of multiple webbing straps secured at several intersections by O-rings and stitching arrangements to ensure that the skeletal structure is one continuous piece. The skeletal structure may be supported by a fabric covering such as a high tensile nylon which maintains the skeletal structure and provides suitable padding for comfort. In the drawings, a D-ring is shown as the single attachment means, the D-ring being securely connected to the skeletal structure to provide a single point attachment means. It will be obvious that while the present harness assembly utilizes a D-ring as the single point attachment means, an O-ring, a looped high tensile material or similar means may be used in its stead.

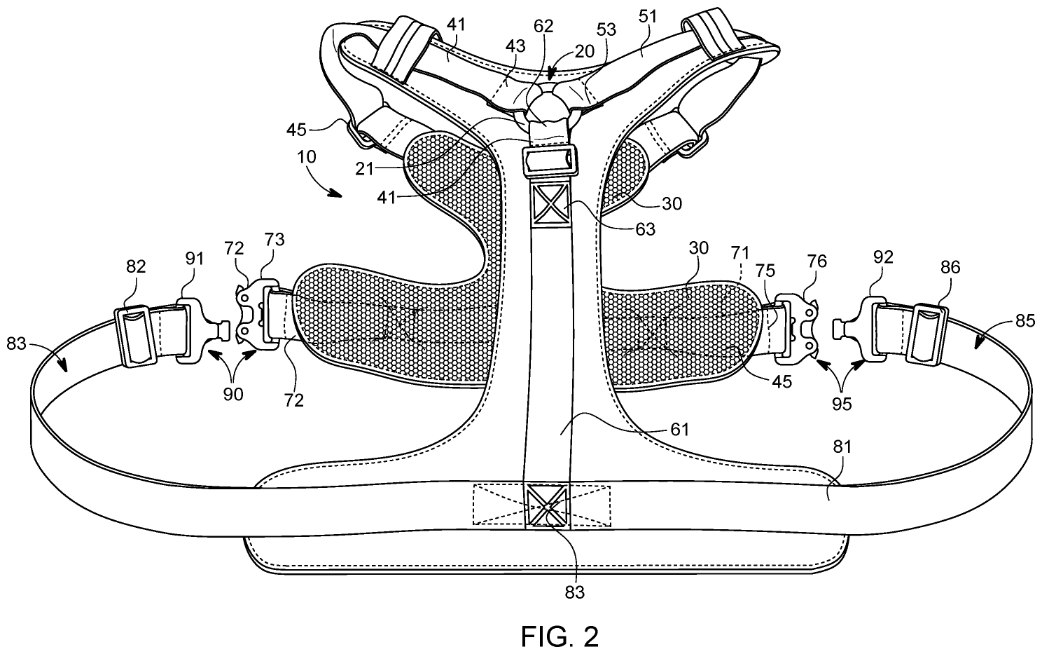

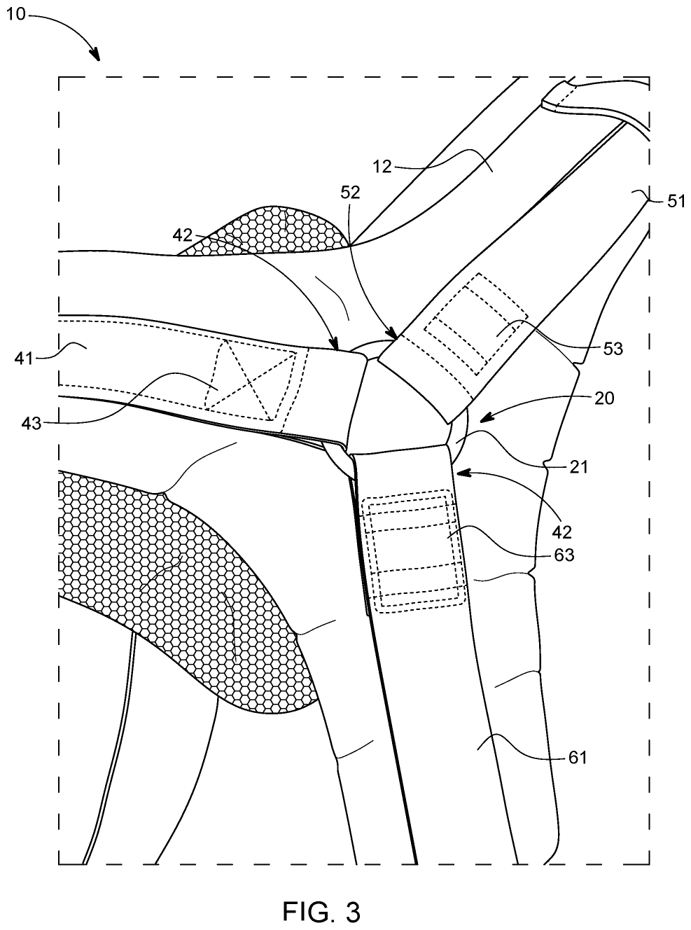

As generally shown in the figures, the harness assembly 10 of the present subject matter comprises multiple webbing straps securely connected by O-rings to form a continuous skeletal structure. Preferably, the webbing straps are composed of high tensile nylon. However, as will be well known to those skilled in the art, other materials which provide strength and durability may be used. More particularly and referring to FIG. 2 and FIG. 3, the multiple webbing straps of the harness system comprise a rear connecting strap 34, a pair of neck straps 41 and 51, a chest strap 61, a back strap 71 and a lateral strap 81.

Neck strap 41 has a proximal end 42 and a distal end 45, neck strap 51 has a proximal end 52 and a distal end 55 and chest strap 61 has a proximal end 62 and a distal end 65. The proximal ends 42, 52 and 62 are securely connected to an O-ring 21 by means of a standard stitched loop arrangement. More specifically, the proximal end 42 of first neck strap 41, is secured to O-ring 21 by means of a looping and stitching arrangement 43. Similarly, the proximal end 52 of second neck strap 51 is secured to O-ring 21 by means of looping and stitching arrangement 53. And the proximal end 62 of chest strap 61 to O-ring 21 by means of a looping and stitching arrangement 63. The interconnection of the pair of neck straps 41 and 51 and the chest strap 61 form the chest portion 20 of the present harness assembly.

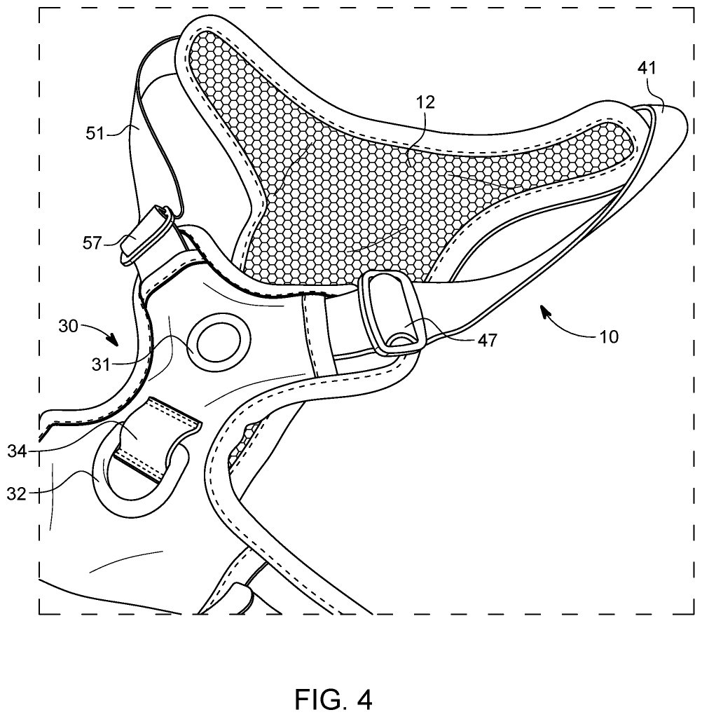

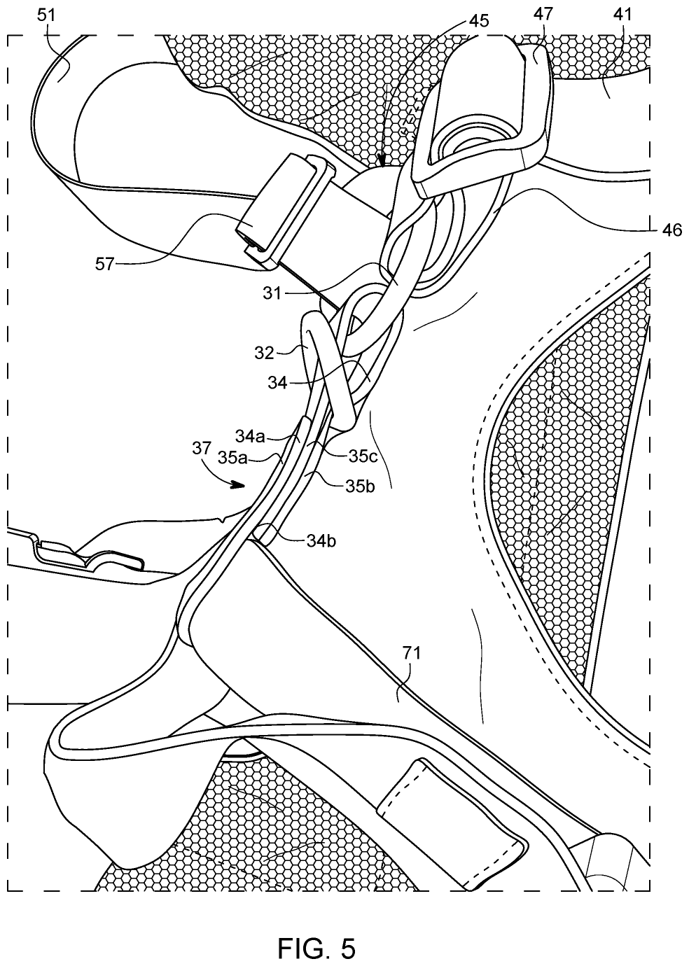

The chest portion 20 is securely connected to a back portion 30 having a single point attachment means 32. Referring now to FIG. 4 and FIG. 5, the back portion 30 comprises an O-ring 31 to which each of the distal ends of webbing straps 41 and 51 are secured by means of a conventional looping arrangement. In particular, the pair of neck straps 41 and 51 extend upwardly from the O-ring 21 in such manner that distal end 45 of webbing strap 45 is secured to O-ring 31 by means of a looping arrangement 46 while distal end 55 of webbing strap 51 is secured to O-ring 31 by means of a looping arrangement 56. In this manner, the chest portion 20 is securely connected to the back portion 30. Each of the looping arrangements 46 and 56 further comprise a looping ring and buckle system 47 and 57 respectively as will be well known to those skilled in the art, thereby providing means to adjust the fit of the harness assembly to the size of the animal.

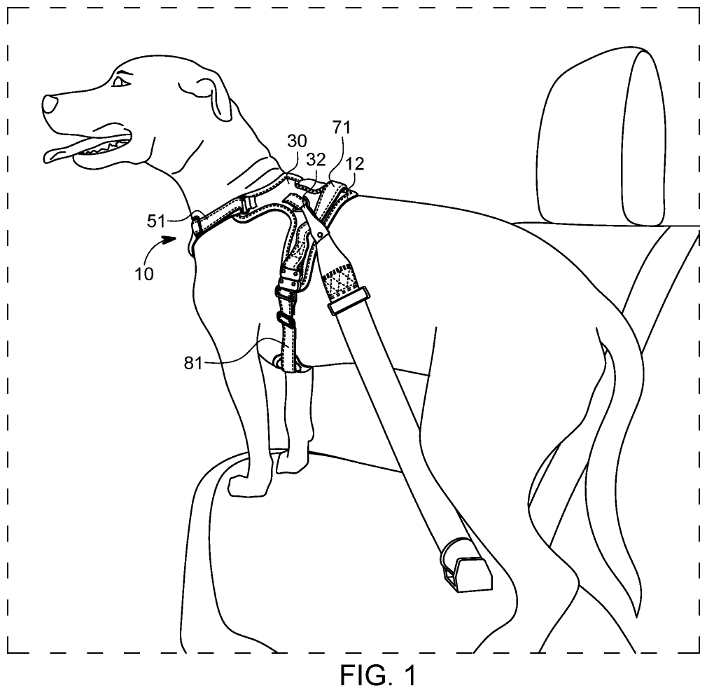

As best viewed in FIG. 5, the rear webbing strap 34 also is secured to O-ring 31 in such a manner that a single point attachment means 32 can be secured to the skeletal structure of the harness assembly 10. In the preferred embodiment illustrated in the drawings, the single point attachment means of the present subject matter is shown as a D-ring 32. However, as will be obvious to those skilled in the art, the single point attachment means could be an O-ring or any suitable looped device. Rear connecting strap 34 is looped and wrapped about the back strap 71 and is looped and stitched in such a manner that it forms three layers, the proximal end 34A forming a first or top layer 35A of the webbing strap 34 which is looped under and wrapped about the back strap 71 such that a second or bottom layer 35B is formed which extends and is looped through an O-ring 31, the resulting loop forming a third or middle layer 35C wherein all three layers 35A, 35B and 35C are stitched together at a three-layered stitched attachment point 37 proximal to the rear webbing strap 71. Between the three-layered stitched attachment point 37 and the O-ring 31, the second layer 35B and third layer 35C also are securely looped about the D-ring 32. In this manner, the D-ring 32 is securely affixed to the skeletal structure of the harness assembly. As shown in FIG. 1, the single point attachment means 32 can be detachably connected to a device for restraining a dog to a vehicle seat. And as will be obvious to those skilled in the art, the single point attachment feature 32 also is capable of being easily connected to a leash by means of a simple releasable clip.

It is to be understood that the D-ring 32 can be secured to the rear strap 71 of the harness assembly by means other than the three-layered stitched attachment point 37. For example, and which will be obvious by those skilled in the art, the D-ring 32 can be secured by an anchor tie or other connecting device. Or, the stitched attachment point can be any multi-layered stitching arrangement. Any suitable means which is sufficient to withstand a high impact force is suitable for connecting the single point attachment means to the skeletal structure and is contemplated to be within the scope of the invention. For example, such suitable means should be capable to withstand at least 30 mph forces exerted in an automobile accident.

Referring again to FIG. 2, chest strap 61 extends downwardly from the chest portion 20 of the harness assembly and is securely connected to the lateral strap 81 by means of a stitched looped arrangement 83 at or about the midpoint of rear webbing strap 81. Rear webbing strap 81 comprises a proximal end 83 and a distal end 85. The proximal end 83 of the webbing strap 81 is looped about an adjustable loop buckle 82 and to a coupling means 91 which is the male member of a first quick release buckle 90. Similarly, the distal end 85 of the webbing strap 81 is looped about an adjustable loop buckle 86 and to a coupling means 92 which is the male member of a second quick release buckle 100. Back strap 71 comprises a proximal end 73 having a coupling means 72 in the form of a female member which is configured to engage male coupling means 91 in such a manner to form the first quick release buckle 90. Similarly, the rear webbing strap 71 comprises a distal end 75 having a coupling means 76 in the form of a female member which is configured to which engage coupling means 92 in such a manner to form a second quick release buckle 95. In operation, once the harness assembly of the present subject matter has been fitted on the animal, the looping arrangements 46 and 56 are adjusted to the size of the animal, the two quick release buckles are securely engaged and the loop buckles 82 and 86 are adjusted to the size of the animal.

The quick release buckles 90 and 95 used in the harness assembly of the present invention are designed to provide quick release even when the associated webbing straps are under tension, such as caused due to a high impact force. The use of such quick release buckles ensures that the restrained animal can be quickly and easily removed in the event of a high impact incident. In this manner, the harness assembly of the present subject matter is crash test worthy. Other buckles commonly used in dog harness systems typically are nesting and only are capable of being unlocked when there is slack in the webbing belts.

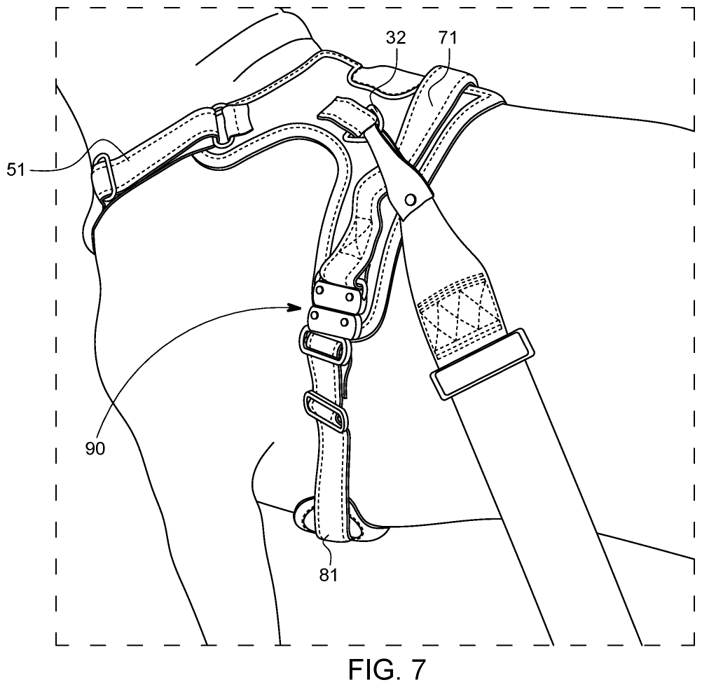

FIG. 7 shows another embodiment of the present invention wherein each of the distal ends of each of the neck straps 41 and 51 are secured to D-rings by means of a looped stitched arrangement and two additional front straps having proximal ends also are secured to the D-rings by means of a looped stitched arrangement. The distal ends of the additional front straps then are secured to the O-ring 31 by means of a looped stitched arrangement.

It is contemplated that various accessories can be incorporated into the harness assembly of the present subject matter without deviating from strong skeletal structure. Suitable examples of such accessories include, but are not limited to, one or more navigation lights attached to the chest portion and/or the back portion of the harness system, saddle bags attached to the sides of the harness structure and reflective strips that can be attached to one or more of the multiple webbing straps.

In a preferred embodiment, the continuous skeletal structure of the present subject matter can be supported by a fabric covering or padding 12 to provide additional comfort to the animal. The fabric covering or padding 12 can be attached to the skeletal structure by any suitable means as will be obvious to those skilled in the art. Referring to FIG. 3, the fabric covering or padding 12 can be secured to the multiple webbing straps by a stitching arrangement 14.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A harness assembly having a single point attachment means comprising multiple webbing straps connected by at least two O-rings and to form a skeletal structure, each of said multiple webbing straps having a proximal end and a distal end, wherein said multiple webbing straps include a pair of neck straps, a chest strap, a back strap, a lateral strap and a rear connecting strap, said proximal ends of said pair of neck straps and said proximal end of said chest strap being securely connected to a first O-ring, said distal ends of said pair of neck straps and said proximal end of said rear connecting strap being securely connected to a second O-ring, said distal end of said rear connecting strap being wrapped about said back strap and being configured in such a manner to securely connect single point attachment means to said skeletal structure, said distal end of said chest strap being secured to said lateral strap.

2. The harness assembly in accordance with claim 1, wherein said distal ends of each of said pair of neck straps further comprise means for adjusting the length of the neck straps.

3. The harness assembly in accordance with claim 1, wherein said rear connecting strap is securely connected to said single point attachment means in such a manner sufficient to withstand a high impact force of at least 30 mph.

4. The harness assembly in accordance with claim 3, wherein said distal end of said rear connecting strap is overlapped and stitched in a three-layer arrangement to securely connect said single point attachment means to said skeletal structure.

5. The harness assembly in accordance with claim 1, wherein said single point attachment means is in the form of any suitable looped device.

6. The harness assembly in accordance with claim 5, where said single point attachment means is a D-ring.

7. The harness assembly in accordance with claim 1, wherein said lateral strap comprises a proximal end having means for adjusting the length of the lateral strap and having a first male member of a first quick release coupling means secured thereto and a distal end having means for adjusting the length of the lateral strap and having a second male member of a second quick release coupling means secured thereto.

8. The harness assembly in accordance with claim 7, wherein said back strap comprises a proximal end and a distal end, said proximal end being provided with a first female member of quick release coupling means configured to securely engage said first male member, thereby forming a first quick release buckle and a distal end being provided with a second female member of a quick release coupling means configured to securely engage said second male member, thereby formed a second quick release buckle.

9. The harness assembly in accordance with claim 8, wherein said first quick release buckle and said second release buckle are capable of quick release when both said lateral strap and said back strap are under tension.

10. The harness assembly in accordance with claim 7, wherein said lateral strap comprises a proximal end and a distal end and wherein said chest strap is secured to a midpoint on said lateral strap by a stitching arrangement.

11. The harness assembly in accordance with claim 1, wherein said padded fabric covering is secured by a stitching arrangement to the skeletal structure.

12. The harness assembly in accordance with claim 1, wherein said multiple webbing straps are composed of high tensile nylon.
